(19) United States
(12) Patent Application Publication
(10) Pub. No.: US 2010/0034235 A1
(43) Pub. Date: Feb. 11, 2010

(54) Heat sink testing method

(75) Inventor: Chih Peng Chen, Sinjhuang City (TW)

Correspondence Address: NIKOLAI & MERSEREAU, P.A., 900 SECOND AVENUE SOUTH, SUITE 820, MINNEAPOLIS, MN, 55402, US

(73) Assignee: Asia Vital Components Co., Ltd., Sinjhuang City (TW)

(21) Appl. No.: 12/288,522

(22) Filed: Oct. 21, 2008

(30) Foreign Application Priority Data
Aug. 5, 2008 (TW) 097129658

(51) Int. Cl. G01N 25/18

(52) U.S. Cl. 374/44

(57) ABSTRACT

A heat sink testing method for measuring the heat dissipation performance of a heat sink includes the following steps: using at least one fluid supply device to produce an amount of fluid, which has a first temperature and is driven to pass through a heat sink; adjusting an input power to a heat-producing element, so that the heat-producing element produces heat, and the produced heat is transferred to the heat sink to produce heat energy having a second temperature between the heat sink and the heat-producing element; and stopping the adjustment of the input power to the heat-producing element when a preset high limit of the second temperature is reached, and determining the heat dissipation performance of the heat sink according to the input power of the heat-producing element.

### FIELD OF THE INVENTION

The present invention relates to a heat sink testing method, and more particularly to a testing method for measuring the heat dissipation performance of a heat sink.

### BACKGROUND OF THE INVENTION

Various kinds of electronic information products, such as computers, are now very popular and widely employed by users. The demands for electronic information products lead to a rapid development in electronic information industry. All the electronic information products are now designed and improved to run at high speed and have largely increased access capacity. As a result, components and elements in the electronic information products often produce a large amount of heat when they operate at high speed.

For example, among others, the central processing unit (CPU) of a computer produces the largest part of heat in the computer. The CPU would become slow in running when the heat produced and accumulated in the computer gradually increases. When the heat accumulated in the computer exceeds an allowable limit, the computer is subject to the danger of shutdown or even becoming seriously damaged. Moreover, to solve the problem of electromagnetic radiation, a case is used to enclose all the important computer components and elements therein. Therefore, it is a very important issue to quickly dissipate the heat produced by the CPU and other heat-producing elements in the computer case.

Normally, a heat sink will be mounted to a heat-producing element in an electronic apparatus to help in dissipating the heat produced by the heat-producing element. The heat sink must be tested in the manufacturing process to determine whether the heat sink is good or poor in its heat dissipation performance. In a conventional way of testing the heat dissipation performance of a heat sink, the heat sink is mounted to a heat-producing element. Meanwhile, a cooling fan is mounted to one side of the heat sink for driving a heat-dissipating fluid through the heat sink to carry heat away from the heat sink. The heat-dissipating fluid has a first temperature or room temperature before it enters the heat sink. The heat-dissipating fluid flows through the heat sink to carry heat away from the heat sink and produces a second temperature. On the other hand, when an input power is input to the heat-producing element, the heat-producing element will produce heat energy, which is further transferred to the heat sink mounted to the heat-producing element, so that a third temperature is produced between the heat-producing element and the heat sink. In the conventional way, the heat dissipation performance of a heat sink is determined by a thermal resistance value between the heat-producing element and the heat sink. The thermal resistance value is a ratio of the temperature change in the heat sink (the third temperature minus the first temperature) to the heat energy produced by the heat-producing element due to the input power thereof. Therefore, in the conventional way of testing heat dissipation performance, the input power to the heat-producing element is under control for the produced heat energy to be a fixed value, and the high/low of the third temperature produced between the heat sink and the heat-producing element is used to determine the heat dissipation performance of the heat sink. However, since the difference between the third temperature and the first temperature is very small and tends to be affected by the air produced by the cooling fan or other factors, the first temperature and accordingly, the difference between the third and the first temperature are unstable and subject to change. As a result, it is uneasy to determine the heat dissipation performance of the heat sink.

It is therefore tried by the inventor to develop a heat sink testing method to eliminate the problems and drawbacks in the conventional way of determining the heat dissipation performance of a heat sink.

### SUMMARY OF THE INVENTION

A primary object of the present invention is to provide a heat sink testing method for measuring and determining the heat dissipation performance of a heat sink.

To achieve the above and other objects, the heat sink testing method according to the present invention includes the following steps: using at least one fluid supply device to produce an amount of fluid, which has a first temperature and is driven to pass through a heat sink; adjusting an input power to a heat-producing element, so that the heat-producing element produces heat, and the produced heat is transferred to the heat sink to produce heat energy having a second temperature between the heat sink and the heat-producing element; and stopping the adjustment of the input power to the heat-producing element when a preset high limit of the second temperature is reached, and determining the heat dissipation performance of the heat sink according to the input power of the heat-producing element.

The present invention provides at least the following advantages: (1) the heat dissipation performance of a heat sink can be more accurately determined; (2) the determination of heat dissipation performance is not easily affected by external factors; and (3) the parameter used in the testing method can be finely adjusted at any time.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing the steps included in a heat sink testing method according to a preferred embodiment of the present invention; and

FIG. 2 is a structural view showing the implementing of the heat sink testing method according to the preferred embodiment of the present invention.

### DETAILED DESCRIPTION OF THE PREFERRED EMBODIMENTS

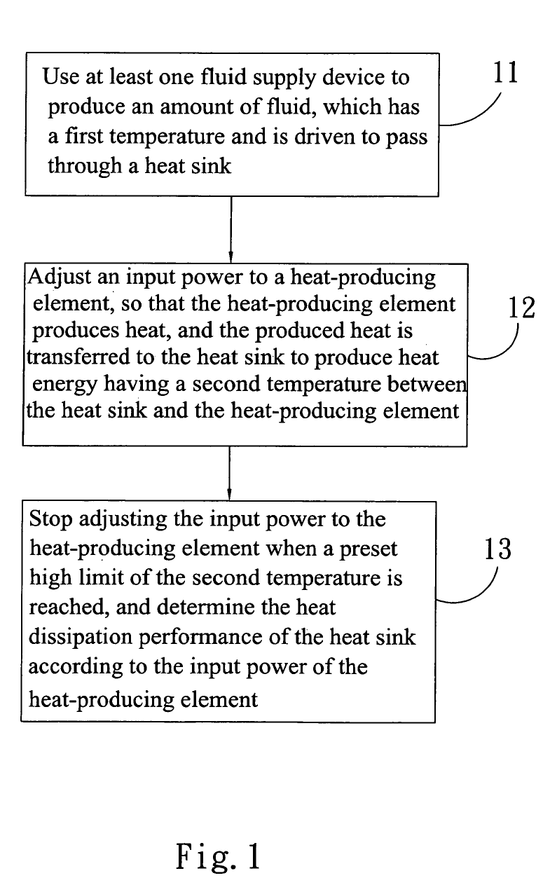

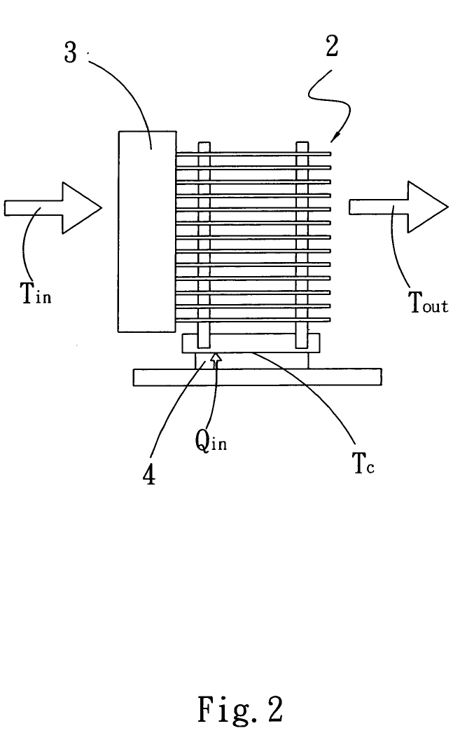

Please refer to FIG. 1 that is a block diagram showing the steps included in a heat sink testing method according to a preferred embodiment of the present invention, and to FIG. 2 that is a structural view showing the implementing of the heat sink testing method according to the preferred embodiment of the present invention.

As shown in FIGS. 1 and 2, the heat sink testing method of the present invention includes the following steps:

In a first step 11, at least one fluid supply device is used to produce an amount of fluid, which has a first temperature and is driven to pass through a heat sink.

More specifically, a fan 3 is mounted to one side of a heat sink 2 undergoing a heat dissipation performance test. The fan 3 operates to produce and drive an amount of heat-dissipating fluid through the heat sink 2, so as to carry heat away from the heat sink 2. The heat dissipating fluid has a first temperature Tᵢₙ, which is room temperature.

In a second step 12, an input power to a heat-producing element is adjusted, so that the heat-producing element produces heat, and the produced heat is transferred to the heat sink to produce heat energy having a second temperature between the heat sink and the heat-producing element.

More specifically, the heat sink 2 is mounted atop a heat-producing element 4. When an input power Qᵢₙ to the heat-producing element 4 is adjusted, the heat-producing element 4 produces heat, which is transferred to the heat sink 2, so that a second temperature T_{c} is produced between the heat-producing element 4 and the heat sink 2.

In a third step 13, the input power to the heat-producing element is adjusted until a preset high limit of the second temperature is reached, and a heat dissipation performance of the heat sink is determined according to the input power of the heat-producing element.

More specifically, when implementing a heat dissipation performance test on the heat sink 2, the input power Qᵢₙ to the heat-producing element 4 is adjusted, so that the heat produced by the heat-producing element 4 has a rising temperature to raise the second temperature T_{c}, accordingly. In the present invention, a high limit is preset for the second temperature T_{c}. When the second temperature T_{c} reaches at the preset high limit, the adjustment of the input power Qᵢₙ to the heat-producing element 4 is immediately stopped. Then, the heat dissipation performance of the heat sink 2 is determined according to the input power Qᵢₙ of the heat-producing element 4.

In the above-described heat sink testing method, a ratio of the second temperature T_{c} to the input power Qᵢₙ of the heat-producing element 4 is defined as a thermal resistance value R_{ca}. The thermal resistance value R_{ca} is calculated using the following formula:

R_{ca}=ΔT/Qᵢₙ

where, ΔT=(T_{c}−Tᵢₙ);
T_{c} is the second temperature and has a high limit;
Tᵢₙ is the first temperature and is usually the room temperature; and
Qᵢₙ is the input power to the heat-producing element.

The input power Qᵢₙ to the heat-producing element 4 can be adjusted corresponding to factors causing changes in the first temperature Tᵢₙ.

In the heat sink testing method of the present invention, a high limit of the second temperature T_{c} is preset. When heat energy is produced by the heat-producing element 4 due to the input power thereto, the second temperature T_{c} is driven to rise. When the rising second temperature T_{c} reaches at the preset high limit thereof, the input power Qᵢₙ to the heat-producing element 4 is stopped, and the heat dissipation performance of the heat sink 2 is determined according to the input power Qᵢₙ at the time the high limit of the second temperature is reached. That is, the higher the input power Qᵢₙ is, the higher the heat dissipation performance of the heat sink 2 is; and, the lower the input power Qᵢₙ is, the lower the heat dissipation performance of the heat sink 2 is.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A heat sink testing method for measuring the heat dissipation performance of a heat sink, comprising the following steps:
using at least one fluid supply device to produce an amount of fluid, and the fluid having a first temperature and being driven to pass through a heat sink;
adjusting an input power to a heat-producing element, so that the heat-producing element produces heat, and the produced heat is transferred to the heat sink to produce heat energy having a second temperature between the heat sink and the heat-producing element; and
stopping the adjustment of the input power to the heat-producing element when a preset high limit of the second temperature is reached, and determining the heat dissipation performance of the heat sink according to the input power of the heat-producing element.

2. The heat sink testing method as claimed in claim 1, wherein the second temperature of the heat energy produced between the heat sink and the heat-producing element is produced corresponding to the adjustment of the input power to the heat-producing element.

3. The heat sink testing method as claimed in claim 1, wherein a ratio of the second temperature to the input power of the heat-producing element defines a thermal resistance value R_{ca}, and the thermal resistance value is calculated using the following formula:
R_{ca}=ΔT/Qᵢₙ
where, ΔT=(T_{c}−Tᵢₙ);
T_{c} is the second temperature and has a high limit;
Tᵢₙ is the first temperature and is usually the room temperature; and
Qᵢₙ is the input power to the heat-producing element.

4. The heat sink testing method as claimed in claim 2, wherein the input power to the heat-producing element can be adjusted corresponding to factors causing changes in the first temperature.

5. The heat sink testing method as claimed in claim 3, wherein the input power to the heat-producing element can be adjusted corresponding to factors causing changes in the first temperature Tᵢₙ.
